(19) United States
(12) Patent Application Publication
(10) Pub. No.: US 2016/0267941 A1
(43) Pub. Date: Sep. 15, 2016

(54) Selfie-Graph

(71) Applicant: Mark Carlson, Carrollton, TX (US)

(72) Inventor: Mark Carlson, Carrollton, TX (US)

(21) Appl. No.: 14/643,158

(22) Filed: Mar. 10, 2015

(51) Int. Cl. G11B 27/031; G06K 9/22; G06K 9/00; H04N 5/272; H04N 5/232

(52) U.S. Cl. CPC G11B 27/031; H04N 5/272; H04N 5/23229; G06K 9/00161; G06K 9/22

(57) ABSTRACT

The present invention relates to a photography method that is enabled with the feature of autographing a photograph at a mobile terminal and can be implemented on any communication device that has hardware components that can perform wireless and wired communication, such as multi-purpose pocket computers and personal multimedia devices.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The present invention relates to the field of photograph methods. In particular, the present invention relates to a photography method that is enabled with the feature of autographing a photograph at a mobile terminal.

(2) Background of Invention

At present, although IT has become increasingly developed recently, some important documents must have the signature or signatures of the photographer printed personally. If you need a signature file from a distant land, it would need to be shipped to the artist or author and signed personally. Also, new computer hardware and software technologies have been developed and are widely used to produce customized photographs posters, and other graphic materials.

One technology in the prior art discloses a clear sheet that has a separate signature on the sheet. The signature is related to, for example, a baseball player, so that the signature can be placed over a picture of the baseball player. This method employs the process of obtaining a signature of the player so that the signature can be thereafter affixed to a picture of the player. Another technology in the prior art discloses a method of using a personal computer and a printer to imprint messages onto the back of photographs. Specifically, the method includes the step of directly imprinting a message onto the reverse side of a photograph so that the photographic card can be used for picture postcards for a plurality of different kinds of applications, including direct mail advertising, personal greeting cards, etc. Also, technology in the prior art discloses a storage and retrieval method for photographic images, wherein the images are digitally stored on a compact disk.

A plurality of photographic images captured on a photographic recording medium are digitized for processing and subsequently displayed. The digitized images are stored on a compact disk. When the disk is inserted into a playback device, such as a color TV monitor, the pictures are displayed in an upright orientation. Furthermore, another technology in the prior art discloses a method of combining a digitally generated image and a pre-stored digital image. The method includes the steps of providing a pre-stored digital image that has at least one discrete predetermined location where a first digitally generated image is placed, providing the first digital generated image at the at least one discrete predetermined location, and combining the first digitally generated image with the pre-stored digital image, such that the first digitally generated image in the at least one discrete predetermined location of the pre-stored digital image forms a single merged message. By way of example, the digital generated image may be an image and/or text.

Furthermore, some technology in the prior art discloses a process of electronically capturing a handwritten signature. The handwritten signature can relate to a document, such as an electronically stored document. The image is displayed, a user signs the document electronically, and the handwritten signature is electronically captured. The signature can also be transmitted through an encryption process. Another prior art discloses a method of creating a card with a photograph and a customized message. It includes a system to send a card with a photograph, remotely create a postcard with a photo taken by a sender, and send the postcard to any destination regardless of who is to receive it. In particular, a customer can use a photo terminal that has a communication capacity connected via a computer network to the computer system at a print shop to request that the print shop remotely create and send a card with a photo on it. The image to be printed on the card and the text data, including the name and address of the recipient and the name of the sender, are transmitted from the photo terminal to the computer network. The customer then requests that the print shop remotely create and send the card. The computer system at the print shop receives the image, sent via the computer terminal, and the order to print and send the postcard. The system prints the image and the specific text data it has received on a card to create a picture postcard, which is then sent.

Other prior arts discloses an imagery system that is stenographically encoded with message data to serve a variety of purposes; a method and apparatus for storing and viewing sports cards on a computer; a celebrity autograph collector disk system that has a picture and other information about the celebrity on one part of the disk, and room on the back side of the disk for other items, including a signature. While various apparatuses, methods, and programs have been developed that utilize computer technologies to produce personalized photographs, currently there is no commercially available method and program that allows a user to quickly and easily print-out an autographed photograph of a celebrity figure with text messages written in a font resembling the handwriting of the celebrity figure.

Therefore, it is still desirable to have a quick and easy method and system that can produce a digital photograph and enables a user to edit the autograph using handwriting or input non-photographic material, such as text.

### BRIEF SUMMARY OF THE INVENTION

The primary objective of the invention is to provide a system for creating an augmented JPEG file that contains both photographic and non-photographic material in a single file. The invention includes a camera for producing a digital photograph that contains a plurality of pixels, a means for storing, processing, and displaying the digital photograph on a device, such as a mobile phone, wherein the device has a storage medium, a microprocessor, a display medium, and a pattern recognition unit for capturing a signature and inputting said signature in a graphical form. Furthermore, the invention has a means for adding the signature to the JPEG file to create an augmented digital photograph that has non-photographic material embedded within the digital photograph when displayed in the display.

In one embodiment, the present invention is a computer-implemented method for creating an augmented JPEG file. The method is comprised of a plurality of steps, which are creating a digital photograph that has a plurality of pixels, storing the digital photograph to a storage medium of a device that has a microprocessor and a display medium, editing the digital photograph using a data entry device by overlaying some of the pixels of the digital photograph with textual material, further storing some of the pixels as well as the textual material in photography tag markers appended, to the digital photograph to create the augmented JPEG file, and then uploading said digital photograph via computer network onto a server for online sharing of the digital photograph.

In yet another embodiment of the invention, the invention includes an augmented JPEG file for displaying a photograph on a display device. The file includes a plurality of digital pixels used to create the photograph that are comprised of photography tag markers affixed to the augmented JPEG file defining the attributes of non-photographic material, as well as actual non-photographic material embedded into the photograph when the photograph is displayed on the display device.

Additionally, in one embodiment of the invention, the augmented JPEG file has photography tag markers, which include a displayable text marker provided with the pixels of said photograph that is overlaid by said non-photographic material embedded into said photograph. Furthermore, the photography tag markers also include a non-displayable data marker that includes the non-photographic material embedded into the photograph, as well as textual non-photographic material appended to the borders of the photograph.

The summary is provided to introduce a selection of concepts in a simplified form that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting. These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### DETAILED DESCRIPTION OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication, such as but not limited to)—multi-purpose pocket computers, personal multimedia devices, etc.

The various devices on which the applications that implement the present invention run may use one or more processors with different instruction-sets, architectures, clock-speeds, and memory that may include high speed random access memory. These may include non-volatile memory, such as one or more magnetic disk storage devices, flash memory devices, and other kinds of solid-state memory devices.

The various applications that can implement the present invention run on electronic devices that may use at least one physical user interface device that provide the means of control and navigation within the operating system. Applications that run on the devices include (but not limited to) touch-pads, such as those described in (but not limited to)—(1) U.S. patent application Ser. No. 10/722,948 (“Touch pad for handheld device”, filed Nov. 25, 2003); (2) U.S. patent application Ser. No.10/188,182 (“Touch pad for handheld device”, filed Mar. 21, 2006); (3) U.S. patent application Ser. No. 08/210,610 (“Computer system with touchpad support in operating system”, filed Mar. 18, 1994); (4) U.S. patent application Ser. No. 643,256 (“Movable touch pad with added functionality”, filed Ser. No. 10/643,256), touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive input Devices,” filed on Jul. 30, 2004; (4) U.S. patent application Ser. No. 11/048,264, “Gestures For Touch Sensitive input Devices,” filed on Jan. 31, 2005; (5) U.S. patent application Ser. No. 11/038,590, “Mode-Based Graphical User Interfaces For Touch Sensitive input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheel such as those described in U.S. patent application Ser. No. 11/549,619 “Method, device, and graphical user interface for dialing with a click wheel” filed on Oct. 13, 2006, keyboards such as those mentioned in (but not limited to) U.S. patent application number Ser. No. 07/711,760 (“Ergonomic keyboard input device”, filed on Jun. 6, 1991), mouse such as those described in (but not limited to) (1) Application Ser. No. 09/167,314 (“Computer mouse with enhance control button (s)”, filed on Oct. 6, 1998); (2) Application Ser. No. 08/288,945 (“Roller mouse for implementing scrolling in windows applications”, filed Aug. 10, 1994) and gesture recognition means such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between the user and these electronic devices.

The present invention may be implemented on applications that run on a single or variety of operating system platforms, including but not limited to OS X, WINDOWS, UNIX, IOS, ANDROID, SYMBIAN, LINUX, or embedded operating systems, such as VxWorks.

The present invention may also be implemented to work with various web browsers, including but not limited to Internet Explorer, Mozilla Firefox, Safari, and Opera that access and handle various types of web pages constructed with various mark-up languages, such as HTML, HTML-5, XHTML, XML, etc., and the associated CSS (cascading style sheet) files and java-script files.

The primary objective of the invention is to provide a system for creating an augmented JPEG file that contains both photograph and non-photographic material in a single file. The system includes a camera for producing a digital photograph containing a plurality of pixels, a means for storing, processing, and displaying the digital photograph on a device, such as a mobile phone, wherein the device has a storage medium, a microprocessor, a display medium, and a pattern recognition unit for capturing a signature and inputting it in a graphical form. Furthermore, the invention has a means for adding the signature to the JPEG file to create an augmented digital photograph that has non-photographic material embedded within the digital photograph when displayed on the display.

In one embodiment, the present invention is a computer-implemented method for creating an augmented JPEG file that is comprised of a plurality of steps. These steps are creating a digital photograph that has a plurality of pixels, storing the digital photograph on a storage medium of a device that has a microprocessor and a display medium, editing the digital photograph using a data entry device by overlaying some of the pixels of the digital photograph with textual material, further storing some of the pixels as well as the textual material in photography tag markers appended to the digital photograph to create the augmented JPEG and uploading said digital photograph via a computer network onto a server for online sharing of the digital photograph.

In yet another embodiment of the invention, the invention includes an augmented JPEG file for displaying a photograph on a display device. The file includes a plurality of digital pixels used to create the photograph. These are comprised of photography tag markers that are affixed to the augmented JPEG file defining the attributes of non-photographic material, as well as actual non-photographic material embedded into the photograph when the photograph is displayed on the display device.

Additionally, in one embodiment of the invention, the augmented PEG file has photography tag markers which include a displayable text marker provided with the pixels of said photograph overlaid by said non-photographic material embedded into said photograph. Furthermore, the photography tag markers also include a non-displayable data marker that includes the non-photographic material embedded into the photograph as well as textual non-photographic material appended to the borders of the photograph.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

I claim:

1. A computer implemented system for creating an augmented JPEG file that contains both a photograph and non-photographic material in a single file, comprising:
a camera producing a digital photograph containing a plurality of pixels;
a means for storing, processing, and displaying said digital photograph on a device, provided in said device is a storage medium, a microprocessor, a display medium, and a pattern recognition unit to capturing a signature and input said signal in a graphical form; and
a means for adding said signature to said JPEG file to create an augmented digital photograph that has non-photographic material embedded within said digital photograph when displayed in said display.

2. A computer-implemented method for creating an augmented JPEG file, comprising the steps of:
creating a digital photograph that has a plurality of pixels;
storing said digital photograph to a storage medium of a device that has a microprocessor and a display medium;
editing said digital photograph using a data entry device by overlaying some of the pixels of said digital photograph with textual material;
storing some of said pixels, as well as said textual material, in photography tag markers appended to said digital photograph to create the augmented JPEG file; and
uploading said digital photograph via a computer network on to a server for online sharing of said digital photograph.

3. An augmented JPEG file for displaying a photograph on a display device. Said file includes a plurality of digital pixels that are used to create said photograph, comprising:
photography tag markers affixed to said augmented JPEG file defining the attributes of non-photographic material as well as actual non-photographic material embedded into said photograph when said photograph is displayed on said display device.

4. The augmented JPEG file, in accordance with claim 3, wherein said photography tag markers include a displayable text marker provided with the pixels of said photograph overlaid by said non-photographic material embedded into said photograph.

5. The augmented JPEG file, in accordance with claim 4, wherein said photography tag markers further include a non-displayable data marker including said non-photographic material embedded into the photograph as well as textual non-photographic material appended to said borders of said photograph.
